(19) United States
(12) Patent Application Publication
(10) Pub. No.: US 2026/0051997 A1
(43) Pub. Date: Feb. 19, 2026

(54) RESOURCE ELEMENT GROUP BUNDLE CYCLIC SHIFT

(71) Applicant: QUALCOMM Incorporated, San Diego, CA (US)

(72) Inventors: Chih-Hao LIU, San Diego, CA (US); Jing SUN, San Diego, CA (US)

(21) Appl. No.: 18/808,561

(22) Filed: Aug. 19, 2024

(51) Int. Cl. H04L 5/00; H04L 1/00

(52) U.S. Cl. CPC H04L 5/0094; H04L 1/0071; H04L 5/0053

(57) ABSTRACT

Methods, systems, and devices for wireless communications are described. A user equipment (UE) may receive control signaling indicating a control channel configuration associated with reference signal sharing across multiple control channels of a control resource set cycling of a resource element group (REG) bundles in multiple physical resource groups (PRGs) of the control resource set. The UE may receive reference signals via the PRGs and monitor for at least one control message of a first control channel via a first control channel element (CCE) of a first PRG and a second CCE of a second PRG. In some examples, a quantity of REG bundles per PRG is coprime to a width of an REG bundle interleaver that interleaved the control message into the CCEs.

### FIELD OF TECHNOLOGY

The following relates to wireless communications, including a resource element group bundle cyclic shift.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a control channel configuration associated with reference signal sharing across a set of multiple control channels of a control resource set and with cycling of a set of multiple resource element group (REG) bundles in a set of multiple physical resource groups (PRGs) of the control resource set, receiving a set of multiple reference signals via the set of multiple PRGs of the control resource set, and monitoring for at least one control message of a first control channel of the set of multiple control channels via a first control channel element (CCE) of a first physical resource group (PRG) of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

A UE for wireless communications is described. The UE may include one or more memories storing processor executable code, and one or more processors coupled with the one or more memories. The one or more processors may individually or collectively be operable to execute the code to cause the UE to receive control signaling indicating a control channel configuration associated with reference signal sharing across a set of multiple control channels of a control resource set and with cycling of a set of multiple REG bundles in a set of multiple PRGs of the control resource set, receive a set of multiple reference signals via the set of multiple PRGs of the control resource set, and monitor for at least one control message of a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

Another UE for wireless communications is described. The UE may include means for receiving control signaling indicating a control channel configuration associated with reference signal sharing across a set of multiple control channels of a control resource set and with cycling of a set of multiple REG bundles in a set of multiple PRGs of the control resource set, means for receiving a set of multiple reference signals via the set of multiple PRGs of the control resource set, and means for monitoring for at least one control message of a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

A non-transitory computer-readable medium storing code for wireless communications is described. The code may include instructions executable by one or more processors to receive control signaling indicating a control channel configuration associated with reference signal sharing across a set of multiple control channels of a control resource set and with cycling of a set of multiple REG bundles in a set of multiple PRGs of the control resource set, receive a set of multiple reference signals via the set of multiple PRGs of the control resource set, and monitor for at least one control message of a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

Some examples of the method, UEs, and non-transitory computer-readable medium described herein may further include operations, features, means, or instructions for generating a first channel estimate for the first CCE based on receiving a first reference signal of the set of multiple reference signals via the first PRG and generating a second channel estimate for the second CCE based on receiving a second reference signal of the set of multiple reference signals via the second PRG, where monitoring for the at least one control message may be based on the first channel estimate or the second channel estimate, or both.

In some examples of the method, UEs, and non-transitory computer-readable medium described herein, the control channel configuration indicates the quantity of PRG bundles per PRG of the set of multiple PRGs.

In some examples of the method, UEs, and non-transitory computer-readable medium described herein, the control channel configuration indicates the width of the REG bundle interleaver, a depth of the REG bundle interleaver, a total quantity of REGs, a quantity of REG bundles per CCE, a bandwidth size of the control resource set, or a quantity of REGs per PRG, or any combination thereof.

In some examples of the method, UEs, and non-transitory computer-readable medium described herein, the control channel configuration indicates a first cyclic shift for the first PRG of the set of multiple PRGs.

In some examples of the method, UEs, and non-transitory computer-readable medium described herein, a second cyclic shift for the second PRG of the set of multiple PRGs may be based on the quantity of REG bundles per PRG.

In some examples of the method, UEs, and non-transitory computer-readable medium described herein, the monitoring may include operations, features, means, or instructions for monitoring for the at least one control message of the first control channel of the set of multiple control channels via the first CCE of the first PRG of the set of multiple PRGs and via the second CCE of the first PRG of the set of multiple PRGs based on the quantity of REG bundles per PRG of the set of multiple PRGs being coprime to the width of the REG bundle interleaver that interleaved the at least one control message into the first CCE and the second CCE.

In some examples of the method, UEs, and non-transitory computer-readable medium described herein, the monitoring may include operations, features, means, or instructions for monitoring for the at least one control message of the first control channel of the set of multiple control channels via the first CCE of the first PRG of the set of multiple PRGs and via the second CCE of the first PRG of the set of multiple PRGs based on each REG bundle of the quantity of the set of multiple REG bundles being shifted by the different cyclic shift in the respective PRG of the set of multiple PRGs.

In some examples of the method, UEs, and non-transitory computer-readable medium described herein, the reference signal sharing may be demodulation reference signal sharing.

A method for wireless communications by a network entity is described. The method may include outputting control signaling indicating a control channel configuration associated with reference signal sharing across a set of multiple control channels of a control resource set and with cycling of a set of multiple REG bundles in a set of multiple PRGs of the control resource set, outputting a set of multiple reference signals via the set of multiple PRGs of the control resource set, and outputting at least one control message on a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

A network entity for wireless communications is described. The network entity may include one or more memories storing processor executable code, and one or more processors coupled with the one or more memories. The one or more processors may individually or collectively be operable to execute the code to cause the network entity to output control signaling indicating a control channel configuration associated with reference signal sharing across a set of multiple control channels of a control resource set and with cycling of a set of multiple REG bundles in a set of multiple PRGs of the control resource set, output a set of multiple reference signals via the set of multiple PRGs of the control resource set, and output at least one control message on a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

Another network entity for wireless communications is described. The network entity may include means for outputting control signaling indicating a control channel configuration associated with reference signal sharing across a set of multiple control channels of a control resource set and with cycling of a set of multiple REG bundles in a set of multiple PRGs of the control resource set, means for outputting a set of multiple reference signals via the set of multiple PRGs of the control resource set, and means for outputting at least one control message on a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

A non-transitory computer-readable medium storing code for wireless communications is described. The code may include instructions executable by one or more processors to output control signaling indicating a control channel configuration associated with reference signal sharing across a set of multiple control channels of a control resource set and with cycling of a set of multiple REG bundles in a set of multiple PRGs of the control resource set, output a set of multiple reference signals via the set of multiple PRGs of the control resource set, and output at least one control message on a first control channel of the set of multiple control channels via a first CCE of a first PRG of the set of multiple PRGs and via a second CCE of a second PRG of the set of multiple PRGs, where a quantity of REG bundles per PRG of the set of multiple PRGs is coprime to a width of an REG bundle interleaver that interleaved the at least one control message into the first CCE and the second CCE, or where each REG bundle of the quantity of the set of multiple REG bundles is shifted by a different cyclic shift in a respective PRG of the set of multiple PRGs.

Some examples of the method, network entities, and non-transitory computer-readable medium described herein may further include operations, features, means, or instructions for outputting a second control message on a second control channel of the set of multiple control channels via a third CCE of the first PRG of the set of multiple PRGs, where the at least one control message may be output to a first UE, and the second control message may be output to a second UE.

Some examples of the method, network entities, and non-transitory computer-readable medium described herein may further include operations, features, means, or instructions for selecting the quantity of REG bundles per PRG to be coprime to the width of the REG bundle interleaver.

Some examples of the method, network entities, and non-transitory computer-readable medium described herein may further include operations, features, means, or instructions for selecting a quantity of REGs in an REG bundle, a quantity of REG bundles in the set of multiple REG bundles, and the width of the REG bundle interleaver, where the quantity of REG bundles per PRG may be coprime to the width of the REG bundle interleaver based on the selecting.

Some examples of the method, network entities, and non-transitory computer-readable medium described herein may further include operations, features, means, or instructions for applying a first cyclic shift for the first PRG of the set of multiple PRGs and applying a second cyclic shift for the second PRG based on each REG bundle of the set of multiple REG bundles being shifted by the different cyclic shift in the respective PRG of the set of multiple PRGs.

In some examples of the method, network entities, and non-transitory computer-readable medium described herein, the control channel configuration indicates the quantity of PRG bundles per PRG of the set of multiple PRGs.

In some examples of the method, network entities, and non-transitory computer-readable medium described herein, the control channel configuration indicates the width of the REG bundle interleaver, a depth of the REG bundle interleaver, a total quantity of REGs, a quantity of REG bundles per CCE, a bandwidth size of the control resource set, a quantity of REGs per PRG, or any combination thereof.

In some examples of the method, network entities, and non-transitory computer-readable medium described herein, the control channel configuration indicates a first cyclic shift for the first PRG of the set of multiple PRGs.

In some examples of the method, network entities, and non-transitory computer-readable medium described herein, a second cyclic shift for the second PRG of the set of multiple PRGs may be based on the quantity of REG bundles per PRG.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports a resource element group (REG) bundle cyclic shift in accordance with one or more aspects of the present disclosure.

FIG. 2 shows an example of a wireless communications system that supports an REG bundle cyclic shift in accordance with one or more aspects of the present disclosure.

FIG. 3 shows an example of a control channel configuration that supports an REG bundle cyclic shift in accordance with one or more aspects of the present disclosure.

FIG. 4 shows an example of a process flow that supports an REG bundle cyclic shift in accordance with one or more aspects of the present disclosure.

FIGS. 5 and 6 show block diagrams of devices that support an REG bundle cyclic shift in accordance with one or more aspects of the present disclosure.

FIG. 7 shows a block diagram of a communications manager that supports an REG bundle cyclic shift in accordance with one or more aspects of the present disclosure.

FIG. 8 shows a diagram of a system including a device that supports an REG bundle cyclic shift in accordance with one or more aspects of the present disclosure.

FIGS. 9 and 10 show block diagrams of devices that support an REG bundle cyclic shift in accordance with one or more aspects of the present disclosure.

FIG. 11 shows a block diagram of a communications manager that supports an REG bundle cyclic shift in accordance with one or more aspects of the present disclosure.

FIG. 12 shows a diagram of a system including a device that supports an REG bundle cyclic shift in accordance with one or more aspects of the present disclosure.

FIGS. 13 through 16 show flowcharts illustrating methods that support an REG bundle cyclic shift in accordance with one or more aspects of the present disclosure.

### DETAILED DESCRIPTION

In some wireless communications systems, a user equipment (UE) may search for control signaling from a network entity by monitoring control channel entities (CCEs) of a control resource set. In some cases, one CCE may include six resource element groups (REGs), where each REG corresponds to one resource block in one symbol. CCEs may be mapped to resource blocks in the control resource set with interleaving or non-interleaving. For non-interleaved mapping, all REGs of a CCE may be in continuous resource blocks, and the network entity may use a same precoder for each REG of the CCE. For an interleaved mapping, the network entity may transmit REGs of a CCE in REG bundles across different resource blocks of the control resource set. The network entity may configure an REG bundle size based on a quantity of symbols for the control resource set, and the network entity may use a same precoder within an REG. The UE may receive a demodulation reference signal (DMRS) with the control signaling and perform channel estimation using the DMRS to decode the control signaling.

In some wireless communications systems, such as some Long Term Evolution (LTE) systems, a network entity may transmit a cell-specific reference signal (CRS), which may improve channel estimation performance at UEs. Some wireless communications systems, such as some New Radio (NR) systems, may not implement CRS. To improve channel estimation performance, some wireless communications systems may implement DMRS sharing, where a network entity transmits a common DMRS for multiple control channels of multiple UEs, improving channel estimation quality for each control channel decoding. A network entity may configure common physical resource block (PRB) groups (PRGs) across the control resource set, and the network entity may transmit a shared DMRS for multiple control channels per PRG. The network entity may use a same precoder per PRG. With DMRS sharing, channel estimation performance may be worse at the edge tones of a PRG. After interleaving, if an REG bundle of a control channel for a UE is on an edge resource block of a PRG, the UE may have decreased channel estimation quality. With current techniques for interleaving, additional REG bundles of the control channel for the UE may also be on edge resource blocks of later PRG, such that the UE may have consistently poor channel estimation quality.

A wireless communications system described herein may implement techniques for applying a cyclic shift for REG bundles across PRGs in a control resource set that utilizes DMRS sharing. For example, a network entity or a UE, or both, may implement techniques to configure a quantity of bundles in a PRG to be coprime to an interleaver width for an REG bundle interleaver. Coprime numbers may refer to pairs of numbers that do not have any common factor other than 1. If the quantity of bundles in a PRG and the interleaver width for the REG bundle interleaver are coprime, the REG bundles of a control channel may cycle through resource blocks in different PRGs. In some examples, the network entity may configure a PRG size that is coprime to the interleaver width. Additionally, or alternatively, the network entity may select a quantity of REGs in the control resource set, a quantity of REGs in an REG bundle, or an interleaver depth, or any combination thereof, such that the quantity of REG bundles in a PRG is coprime to the REG bundle interleaver width. In some examples, the network entity may apply different REG bundle cyclic shifts for different PRGs after interleaving. For example, the network entity may apply a pseudo random shift to the REGs within a PRG, such a CCE for a UE does not repeatedly correspond to edge resource blocks of PRGs.

Aspects of the disclosure are initially described in the context of wireless communications systems. Aspects of the disclosure are further illustrated by and described with reference to apparatus diagrams, system diagrams, and flowcharts that relate to an REG bundle cyclic shift.

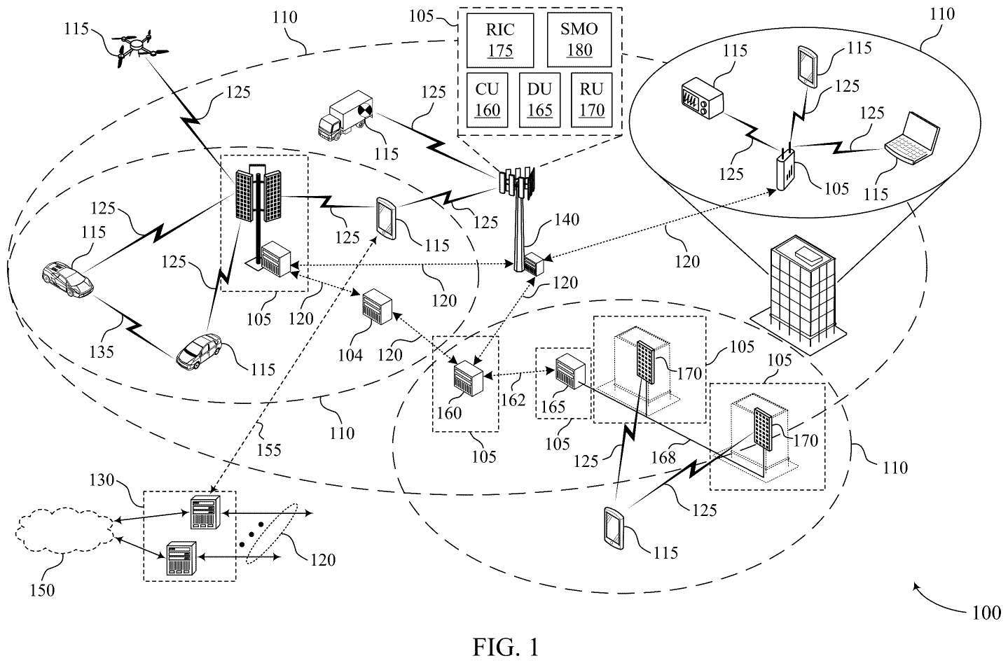

FIG. 1 shows an example of a wireless communications system 100 that supports an REG bundle cyclic shift in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a UE 115 may search for control signaling from a network entity 105 by monitoring CCEs of a control resource set. In some cases, one CCE may include six REGs, where each REG corresponds to one resource block in one symbol. A UE 115 may receive a DMRS with the control signaling and perform channel estimation using the DMRS to decode the control signaling.

CCEs may be mapped to resource blocks in the control resource set with interleaving or non-interleaving. For non-interleaved mapping, all REGs of a CCE may be in continuous resource blocks, and the network entity may use a same precoder for each REG of the CCE. For an interleaved mapping, the network entity 105 may transmit REGs of a CCE in REG bundles across different resource blocks of the control resource set. The network entity 105 may configure an REG bundle size based on a quantity of symbols for the control resource set, and the network entity 105 may use a same precoder within an REG. An REG bundle size may include, for example, two, three, or six REGs based on the quantity of symbols for the control resource set.

In some wireless communications systems, such as an LTE system, a network entity may transmit a CRS, which may improve channel estimation performance at UEs 115. Some wireless communications systems, such as some NR systems, may not implement CRS. To improve channel estimation performance, some wireless communications systems, such as the wireless communications system 100, may implement DMRS sharing, where a network entity 105 transmits a common DMRS for multiple control channels of multiple UEs 115, improving channel estimation quality for each control channel decoding.

A network entity 105 may configure common PRGs across the control resource set, and the network entity 105 may transmit a shared DMRS for multiple control channels per PRG. The network entity 105 may use a same precoder per PRG. With DMRS sharing, channel estimation performance may be worse at the edge tones of a PRG. After interleaving, if an REG bundle of a control channel for a UE 115 is on an edge resource block of a PRG, the UE 115 may have decreased channel estimation quality. With current techniques for interleaving, additional REG bundles of the control channel for the UE 115 may also be on edge resource blocks of later PRG, such that the UE 115 may have consistently poor channel estimation quality in the control resource set.

For example, a control channel, such as a physical downlink control channel (PDCCH), may occupy continuous CCEs for higher aggregation levels. Even for an aggregation level of 1, PDCCH may occupy contiguous REGs for non-interleaved mapping configurations. When interleaving is configured, the CCEs are distributed across multiple PRGs. With some combinations of selections for PRG size, REG bundle size, control resource set size, and interleaver depth, some UEs 115 may be at the edge tone of a PRG and experience increase channel estimation error. The wireless communications system 100 may use techniques to provide for at least some CCEs of a control channel to be in the middle resource blocks of a PRG. Other CCEs of the control channel may be on the edge tones, but channel estimation error may be averaged out for all control channels in the control resource set.

A wireless communications system described herein may implement techniques for applying a cyclic shift for REG bundles across PRGs in a control resource set that utilizes DMRS sharing. For example, a network entity 105 or a UE 115, or both, may implement techniques to configure a quantity of bundles in a PRG to be coprime to an interleaver width for an REG bundle interleaver. If the quantity of bundles in a PRG and the interleaver width for the REG bundle interleaver are coprime, the REG bundles of a control channel may cycle through resource blocks in different PRGs. In some examples, the network entity 105 may configure a PRG size that is coprime to the interleaver width. Additionally, or alternatively, the network entity 105 may select a quantity of REGs in the control resource set, a quantity of REGs in an REG bundle, or an interleaver depth, or any combination thereof, such that the quantity of REG bundles in a PRG is coprime to the REG bundle interleaver width. In some examples, the network entity 105 may apply different REG bundle cyclic shifts for different PRGs after interleaving. For example, the network entity 105 may apply a pseudo random shift to the REGs within a PRG, such a CCE for a UE 115 does not consistently correspond to edge resource blocks of PRGs.

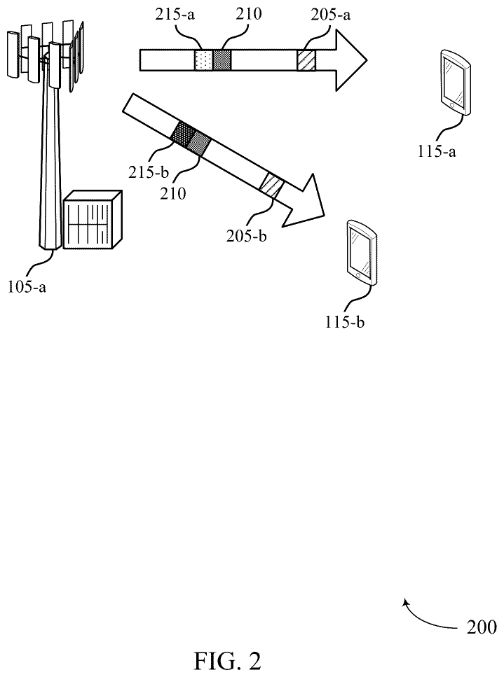

FIG. 2 shows an example of a wireless communications system 200 that supports an REG bundle cyclic shift in accordance with one or more aspects of the present disclosure. The wireless communications system 200 may implement aspects of a wireless communications system 100. For example, the wireless communications system 200 may include a network entity 105-a, a UE 115-a, and a UE 115-b. The network entity 105-a may be an example of a network entity 105 described herein, and the UE 115-a and the UE 115-b may each be an example of a UE 115 described herein.

The wireless communications system 200 may support DMRS sharing for a control resource set. For example, the network entity 105-a may transmit a common DMRS for multiple control channels of multiple UEs 115, such as the UE 115-a and the UE 115-b, improving channel estimation quality for each control channel decoding. The network entity 105-a may configure common PRGs across the control resource set, and the network entity 105-a may transmit a shared DMRS for multiple control channels per PRG. The network entity 105-a may use a same precoder per PRG.

The network entity 105-a may configure a control resource set at the UE 115-a or the UE 115-b, or both. For example, the network entity 105-a may transmit a signal 205-a indicating a control resource set configuration to the UE 115-a. In some examples, the network entity 105-a may transmit a signal 205-b indicating a control resource set configuration to the UE 115-b, or a same signal may indicate the control resource set configuration to the UE 115-a and the UE 115-b.

The control resource set configuration may include a parameter indicating a bandwidth of the control resource set. For example, the control resource set configuration may indicate that the control resource set spans N_{RB} resource blocks. In some examples, the control resource set configuration may indicate a PRG size, N_{PRG}, or a quantity of resource blocks per PRG. The control resource set configuration may indicate a quantity of REGs in the control resource set, N_{REG}, and a quantity of REGs per REG bundle, L. The control resource set configuration may indicate an REG bundle resource block size to be B resource blocks, and the quantity of REG bundles may be N_{RB}/B, equal to N_{REG}/L. In some examples, the control resource set configuration may indicate a CCE interleaver depth as R REG bundles. In some examples, the control resource set configuration may indicate a CCE interleaver width as C resource blocks, equal to N_{REG}/R−L or N_{REG}/B−R. In some examples, the CCE interleaver width C may be an integer quantity of resource blocks. In some examples, a CCE interleaver may be referred to as an REG bundle interleaver.

With DMRS sharing, channel estimation performance may be worse at the edge tones of a PRG. In some systems, if an REG bundle of a control channel for a UE 115 is on an edge resource block of a PRG after interleaving, the UE 115 may have decreased channel estimation quality. With some techniques for interleaving, additional REG bundles of the control channel for the UE 115 may also be on edge resource blocks of later PRG, such that the UE 115 may have consistently poor channel estimation quality in the control resource set.

The wireless communications system 200 may support techniques for applying a cyclic shift for REG bundles across PRGs in a control resource set that utilizes DMRS sharing. For example, the network entity 105-a or the UE 115-a, or both, may implement techniques to configure a quantity of bundles in a PRG to be coprime to an interleaver width for an REG bundle interleaver. If the quantity of bundles in a PRG and the interleaver width for the REG bundle interleaver are coprime, the REG bundles of a control channel may cycle through resource blocks in different PRGs.

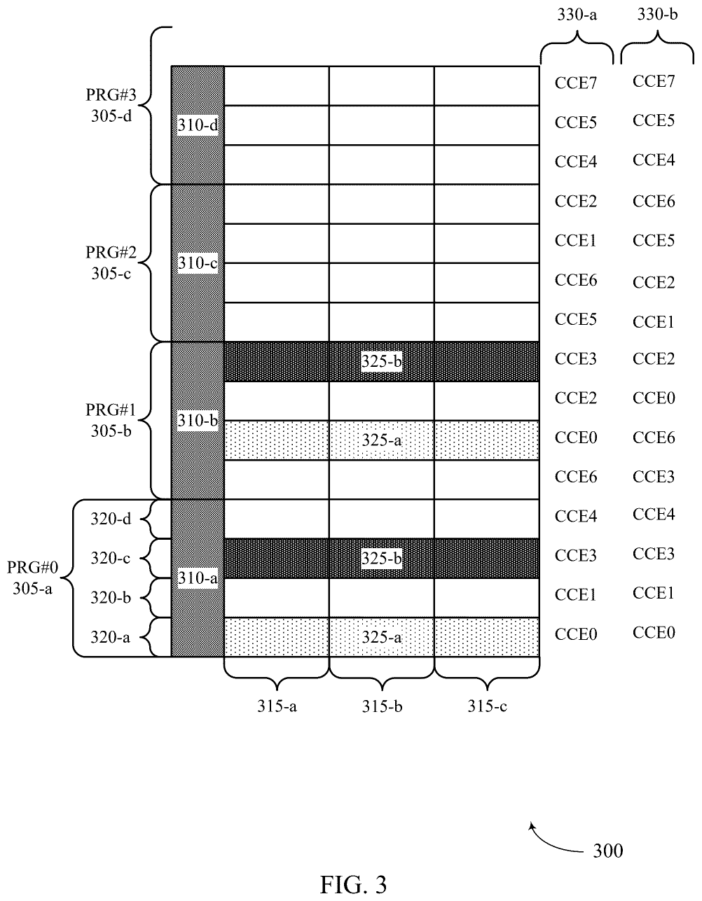

In some examples, the network entity 105-a may configure a PRG size that is coprime to the interleaver width. The network entity 105-a may select a PRG size such that a quantity of REG bundles in a PRG is coprime to an REG bundle interleaver width, C. For example, the PRG size may be 4 and the interleaver width may be 5, and hence the PRG size and the interleaver width are coprime. Other PRG sizes and interleaver widths that are coprime may also be used. In this example, the REG bundles of a control channel (e.g., a PDCCH) may cycle through the resource blocks across PRGs. The network entity 105-a may transmit an indication of the interleaver width and an indication of the PRG size that is coprime to the interleaver width to the UE 115-a in the control resource set configuration via the signal 205-a. An example of REG bundle cycling by using a coprime PRG size and interleaver width is described in more detail with reference to FIG. 3.

Additionally, or alternatively, the network entity 105 may select a quantity of REGs in the control resource set, a quantity of REGs in an REG bundle, or an interleaver depth, or any combination thereof, such that the quantity of REG bundles in a PRG is coprime to the REG bundle interleaver width. For example, for a given PRG size, the network entity 105-a may select values for the quantity of REGs in the control resource set (e.g., N_{REG}), the quantity of REGs in a bundle (e.g., L), and the CCE interleaver depth (e.g., R) such that a quantity of REG bundles in a PRG is prime or coprime to the REG bundle interleaver width, C.

In some examples, the network entity 105-a may apply different REG bundle cyclic shifts for different PRGs after interleaving. For example, the network entity 105-a may apply a pseudo random shift to the REGs within a PRG, such a CCE for a UE 115-a does not consistently correspond to edge resource blocks of PRGs. In some examples, the network entity 105-a may add a pseudo random shift under modulation operation. For example, for PRG i, the bundles may be shifted by ƒ(i)*mod(N_{PRG}), where ƒ(i) is a pseudorandom function based on i, or the index of the PRG.

As an example, ƒ(i) may be equal to i. CCEs in a first PRG, PRG 0, may include CCE 0, CCE 2, CCE 4, and CCE 6, which may be mapped to the 0th through 3rd resource blocks of the first PRG, respectively. CCEs in a first PRG (e.g., PRG 0) may be cyclically shifted by 0, or not cyclically shifted. CCEs in a second PRG (e.g., PRG 1) may be cyclically shifted by 1. For example, PRG 1 may include CCE 6, CCE 0, CCE 2, and CCE 4 mapped to the 0th through 3rd resource blocks of the second PRG, respectively.

The UE 115-a may monitor for control signaling from the network entity 105-a via a control resource set according to the control resource set configuration indicated by the signal 205-a. For example, the UE 115-a may receive one or more DMRS via one or more PRGs. For example, the UE 115-a may receive a DMRS 210 via a first PRG of the control resource set. The UE 115-b may receive the same DMRS (e.g., the DMRS 210) via the first PRG of the control resource set based on DMRS sharing. In some examples, the UE 115-a may receive a second DMRS via a second PRG of the control resource set. The UE 115-a may estimate a downlink control channel in the first PRG based on the DMRS 210.

The UE 115-a may monitor for a control message 215-a via a CCE in the first PRG based on estimating a downlink control channel from the DMRS 210 in the first PRG. In some examples, the UE 115-a may monitor for the control message 215-a via the CCE in a second PRG based on estimating the downlink control channel from a second DMRS in the second PRG. The CCE in the second PRG may be shifted from the CCE in the first PRG. For example, if the CCE is on an edge tone or edge resource block of the first PRG, the CCE may be in a middle tone or a middle resource block of the second PRG based on the techniques described herein. For example, a CCE interleaver may be coprime to a PRG size. Additionally, or alternatively, the network entity 105-a may apply different cyclic shifts to REG bundles in the different PRGs.

The UE 115-b may similarly monitor for a control message 215-b via a second CCE in the first PRG based on estimation a second downlink control channel from the DMRS 210 in the first PRG. For example, the UE 115-a and the UE 115-b may perform channel estimation using a same DMRS per PRG. In some examples, the UE 115-a may monitor for the control message 215-b via the second CCE in the second PRG based on estimating the second downlink control channel from a second DMRS in the second PRG.

FIG. 3 shows an example of an REG bundle cycling configuration 300 that supports an REG bundle cyclic shift in accordance with one or more aspects of the present disclosure.

A network entity 105 may configure a control resource set at a first UE 115 or a second UE 115, or both. The network entity 105 and the UE 115 may support DMRS sharing, where a control resource set includes multiple PRG 305, and a shared DMRS 310 for multiple control channels 325 is transmitted for each PRG 305. Control channels 325 in a first PRG 305-a, such as a control channel 325-a for a first UE 115 and a control channel 325-b for a second UE 115, may share a DMRS 310-a. Similarly, control channels 325 in a second PRG 305-b share a DMRS 310-b, in a third PRG 305-c share a DMRS 310-c, and in a fourth PRG 305-d share a DMRS 310-d.

The network entity 105 may transmit a signal indicating a control resource set configuration to the first UE 115 or the second UE 115, or both. In some examples, the network entity 105 may transmit a common signal indicating a control resource set configuration to the first UE 115 and the second UE 115 or separate signals indicating the control resource configuration. For example, the network entity 105 may indicate the control resource set configuration via system information, RRC signaling, or control signaling.

The control resource set configuration may indicate parameters for a size of the control resource set or a CCE interleaver. For example, the control resource set configuration may indicate a bandwidth of the control resource set. For example, the control resource set configuration may indicate that the control resource set spans N_{RB} resource blocks. In some examples, the control resource set configuration may indicate a PRG size, N_{PRG}, or a quantity of resource blocks per PRG. The control resource set configuration may indicate a quantity of REGs in the control resource set, N_{REG}, and a quantity of REGs per REG bundle, L. The control resource set configuration may indicate an REG bundle resource block size to be B resource blocks, and the quantity of REG bundles may be

$$\frac{{N}_{R B}}{B} ,$$

equal to

$$\frac{{N}_{R E G}}{L} .$$

In some examples, the control resource set configuration may indicate a CCE interleaver depth as R REG bundles. In some examples, the control resource set configuration may indicate a CCE interleaver width as C resource blocks, equal to

$$\frac{{N}_{R E G}}{R - L} or \frac{{N}_{R B}}{B * R} .$$

In some examples, the CCE interleaver width may be an integer quantity of resource blocks. In some examples, a CCE interleaver may be referred to as an REG bundle interleaver. In some examples, the control resource set configuration may indicate a quantity of symbols 315 the control resource set spans.

The wireless communications system 200 may support techniques for applying a cyclic shift for REG bundles across PRGs in a control resource set that utilizes DMRS sharing. For example, the network entity 105-a or the UE 115-a, or both, may implement techniques to configure a quantity of bundles in a PRG to be coprime to an interleaver width for an REG bundle interleaver. If the quantity of bundles in a PRG and the interleaver width for the REG bundle interleaver are coprime, the REG bundles of a control channel may cycle through resource blocks in different PRGs.

The REG bundle cycling configuration 300 corresponds to an example control resource set as configured by a control resource set configuration to support cycling REG bundles across PRGs. For example, a control resource set configuration may indicate that the control resource set includes 45 REGs, 2 REG bundles per CCE, a PRG size of 4, and may span 3 symbols (e.g., including a symbol 315-a, a symbol 315-b, and a symbol 315-c). In some examples, a fourth PRG 305-d may include three REGs instead of four based on the total quantity of REGs in the control resource set. The control resource set configuration may indicate an interleaver depth of 3 and an interleaver width of 5 (e.g., 45 divided by 3 where the result is further divided by 3). The interleaver width may be coprime to the PRG size of four. The interleaver width may be coprime to the PRG size, such that the REG bundles of a control channel 325 cycle through the resource blocks in different PRGs 305.

A mapping 330-a may show an example mapping of CCEs to REG bundles. For example, the control channel 325-a for the first UE 115 may correspond to a first resource block 320-a of the first PRG 305-a (e.g., an edge resource block) and correspond to a second resource block 320-b of the second PRG 305-b (e.g., a middle resource block). The control channel 325-b for the second UE 115 may correspond to a third resource block 320-c of the first PRG 305-a (e.g., a middle resource block) and correspond to a fourth resource block 320-d of the second PRG 305-b (e.g., an edge resource block).

In some examples, the network entity 105 may configure a PRG size that is coprime to the interleaver width. The network entity 105-a may transmit an indication of the interleaver width and an indication of the PRG size that is coprime to the interleaver width to the UEs 115 in the control resource set configuration. Additionally, or alternatively, the network entity 105 may select a quantity of REGs in the control resource set, a quantity of REGs in an REG bundle, or an interleaver depth, or any combination thereof, such that the quantity of REG bundles in a PRG is coprime to the REG bundle interleaver width.

In some examples, the network entity 105 may apply different REG bundle cyclic shifts for different PRGs after interleaving. For example, the network entity 105 may apply a pseudo random shift to the REGs within a PRG, such a CCE for a UE 115 does not consistently correspond to edge resource blocks of PRGs. In some examples, the network entity 105-a may add a pseudo random shift under modulation operation. For example, for PRG i, the bundles may be shifted by ƒ(i)*mod (N_{PRG}), where ƒ(i) is a pseudorandom function based on i, or the index of the PRG.

A mapping 330-b shows an example mapping between CCEs to REG bundles where different cyclic shifts are used for different PRGs 305. As an example, ƒ(i) may be equal to i. CCEs in a first PRG, PRG 0, may include CCE 0, CCE 1, CCE 3, and CCE 4, which may be mapped to the 0th through 3rd resource blocks of the first PRG, respectively. CCEs in a first PRG (e.g., PRG 0) may be cyclically shifted by 0, or not cyclically shifted. CCEs in a second PRG (e.g., PRG 1) may be cyclically shifted by 1. For example, PRG 1 may include CCE 6, CCE 0, CCE 2, and CCE 3 mapped to the 0th through 3rd resource blocks of the second PRG, respectively, resulting in the order of CCE 3, CCE 6, CCE 0, and CCE 2 (from bottom to top). PRG 2 may include CCE 5, CCE 6, CCE 1, and CCE 2 mapped to the 0th through 3rd resource blocks of the third PRG, respectively, which may be cyclically shifted by 2, resulting in the order of CCE 1, CCE 2, CCE 5, and CCE 6 (from bottom to top). PRG 3 may include CCE 4, CCE 5, and CCE 7 mapped to the 0th through 3rd resource blocks of the fourth PRG, respectively, which may be cyclically shifted by 3, resulting in the order of CCE 4, CCE 5, and CCE 7, (from bottom to top).

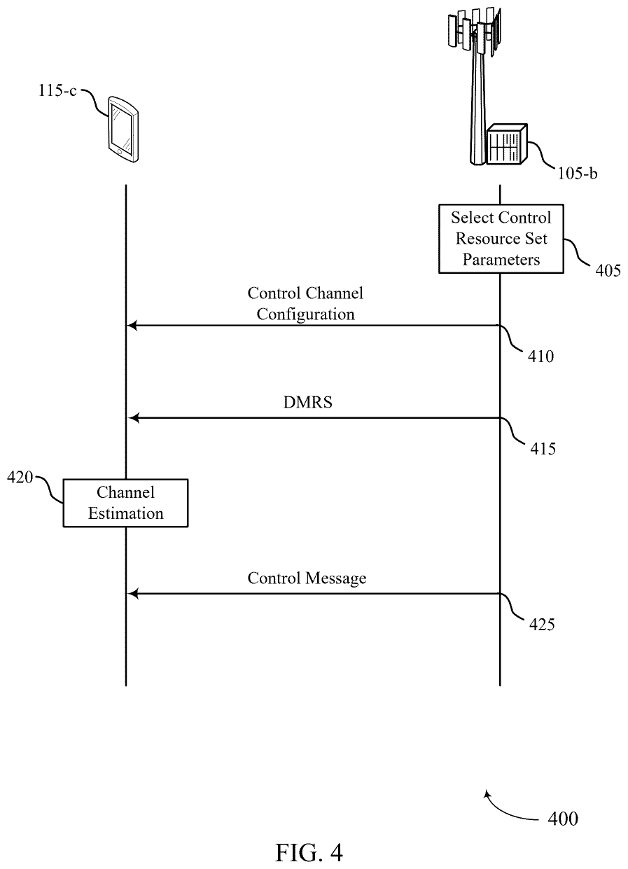

FIG. 4 shows an example of a process flow 400 that supports an REG bundle cyclic shift in accordance with one or more aspects of the present disclosure. The process flow 400 may implement aspects of a wireless communications system 100, a wireless communications system 200 and an REG bundle cycling configuration 300. For example, the process flow 400 may illustrate operations between a UE 115-c and a network entity 105-b, which may be respective examples of a UE 115 and a network entity 105 described herein. In the following description of the process flow 400, some signaling between the UE 115-c and the network entity 105-b may be transmitted in a different order than the example order shown, or the operations performed by the UE 115-c and the network entity 105-b may be performed in different orders or at different times. Some operations also may be omitted from the process flow 400, or other operations may be added to the process flow 400.

At 405, the network entity 105-b may select parameters for a control resource set. For example, the network entity 105-b may select a quantity of REGs in an REG bundle, a quantity of resource element group bundles in the plurality of REG bundles, and a width of the REG bundle interleaver. In some examples, the quantity of REG bundles per physical resource group may be coprime to the width of the REG bundle interleaver. Additionally, or alternatively, the network entity 105-b may select the quantity of REG bundles per PRG to be coprime to the width of the REG bundle interleaver.

At 410, the network entity 105-b may transmit a control signal indicating a control resource set configuration. For example, the network entity 105-b may transmit control signaling indicating a control channel configuration associated with reference signal sharing across a set of control channels of a control resource set and with cycling of a set of REG bundles in a set of PRGs of the control resource set. The UE 115-c may the control signaling indicating the control channel configuration from the network entity 105-b.

At 415, the UE 115-c may receive a set of reference signals via the set of PRGs of the control resource set. For example, the UE 115-c may receive a set of DMRS via the set of PRGs. At 420, the UE 115-c may perform channel estimation based on the set of DMRS. For example, the UE 115-c may estimate a downlink control channel. For example, the UE 115-c may generate a first channel estimate for the first CCE based on receiving a first reference signal of the set of reference signals via the first PRG, and the UE 115-c may generate a second channel estimate for the second CCE based on receiving a second reference signal of the set of reference signals via the second PRG.

At 425, the UE 115-c may monitor for a control message from the network entity 105-b based on the control resource set configuration. For example, the UE 115-c may monitor for at least one control message of a first control channel of the set of control channels via a first CCE of a first PRG of the set of PRGs and via a second CCE of a second PRG of the set of PRGs. In some examples, a quantity of REG bundles per PRG of the set of PRGs is coprime to a width of an REG bundle interleaver that interleaved the at least one control message into the first CCE and the second CCE. In some examples, each REG bundle of the quantity of the set of REG bundles is shifted by a different cyclic shift in a respective PRG of the plurality of PRGs.

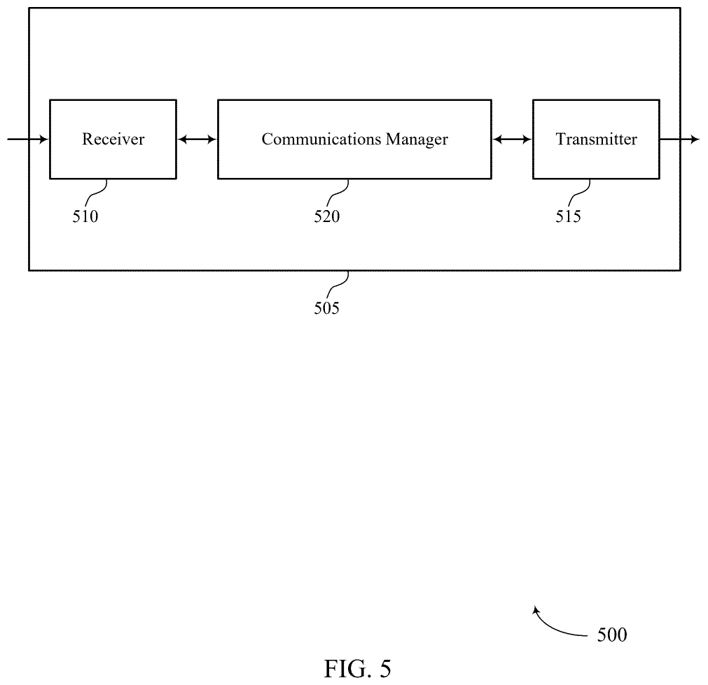

FIG. 5 shows a block diagram 500 of a device 505 that supports an REG bundle cyclic shift in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to an REG bundle cyclic shift). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to an REG bundle cyclic shift). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of an REG bundle cyclic shift as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicating a control channel configuration associated with reference signal sharing across a set of multiple control channels of a control resource set and with cycling of a set of multiple REG bundles in a set of multiple PRGs of the control resource set. The communications manager 520 is capable of, configured to, or operable to support a means for receiving a set of multiple reference signals via the set of multiple PRGs of the control resource set. The communications manager 520 is capable of, configured to, or operable to support a means for monitoring for at least one control message of a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources

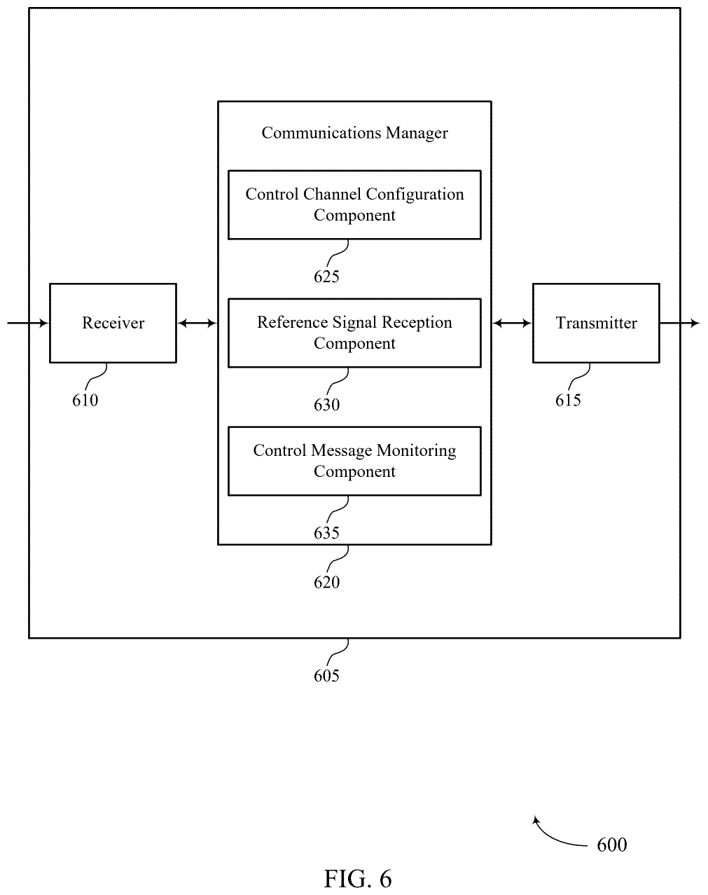

FIG. 6 shows a block diagram 600 of a device 605 that supports REG bundle cyclic shift in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to REG bundle cyclic shift). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to an REG bundle cyclic shift). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of an REG bundle cyclic shift as described herein. For example, the communications manager 620 may include a control channel configuration component 625, a reference signal reception component 630, a control message monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control channel configuration component 625 is capable of, configured to, or operable to support a means for receiving control signaling indicating a control channel configuration associated with reference signal sharing across a set of multiple control channels of a control resource set and with cycling of a set of multiple REG bundles in a set of multiple PRGs of the control resource set. The reference signal reception component 630 is capable of, configured to, or operable to support a means for receiving a set of multiple reference signals via the set of multiple PRGs of the control resource set. The control message monitoring component 635 is capable of, configured to, or operable to support a means for monitoring for at least one control message of a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

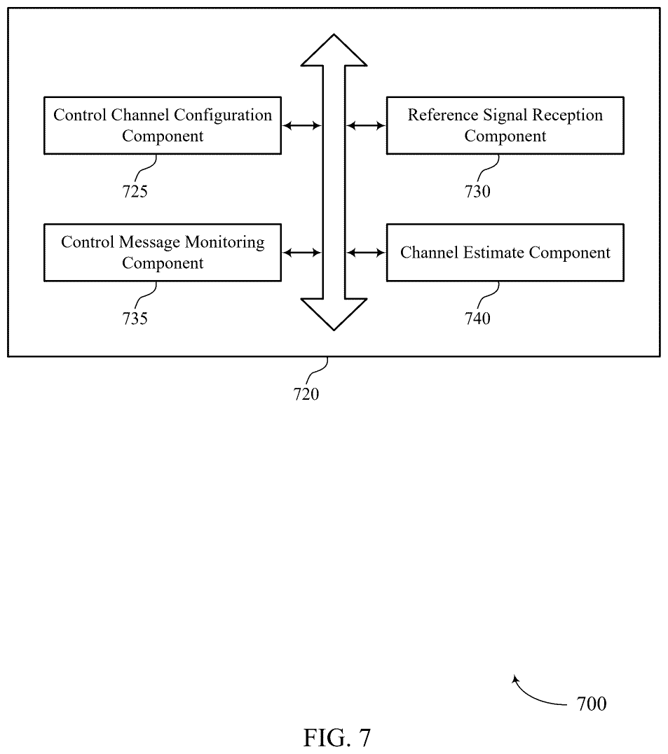

FIG. 7 shows a block diagram 700 of a communications manager 720 that supports an REG bundle cyclic shift in accordance with one or more aspects of the present disclosure. The communications manager 720 may be an example of aspects of a communications manager 520, a communications manager 620, or both, as described herein. The communications manager 720, or various components thereof, may be an example of means for performing various aspects of an REG bundle cyclic shift as described herein. For example, the communications manager 720 may include a control channel configuration component 725, a reference signal reception component 730, a control message monitoring component 735, a channel estimate component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control channel configuration component 725 is capable of, configured to, or operable to support a means for receiving control signaling indicating a control channel configuration associated with reference signal sharing across a set of multiple control channels of a control resource set and with cycling of a set of multiple REG bundles in a set of multiple PRGs of the control resource set. The reference signal reception component 730 is capable of, configured to, or operable to support a means for receiving a set of multiple reference signals via the set of multiple PRGs of the control resource set. The control message monitoring component 735 is capable of, configured to, or operable to support a means for monitoring for at least one control message of a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

In some examples, the channel estimate component 740 is capable of, configured to, or operable to support a means for generating a first channel estimate for the first control channel element based on receiving a first reference signal of the set of multiple reference signals via the first PRG. In some examples, the channel estimate component 740 is capable of, configured to, or operable to support a means for generating a second channel estimate for the second control channel element based on receiving a second reference signal of the set of multiple reference signals via the second PRG, where monitoring for the at least one control message is based on the first channel estimate or the second channel estimate, or both.

In some examples, the control channel configuration indicates the quantity of PRG bundles per PRG of the set of multiple PRGs.

In some examples, the control channel configuration indicates the width of the REG bundle interleaver, a depth of the REG bundle interleaver, a total quantity of REGs, a quantity of REG bundles per control channel element, a bandwidth size of the control resource set, or a quantity of REGs per PRG, or any combination thereof.

In some examples, the control channel configuration indicates a first cyclic shift for the first PRG of the set of multiple PRGs.

In some examples, a second cyclic shift for the second PRG of the set of multiple PRGs is based on the quantity of REG bundles per PRG.

In some examples, to support monitoring, the control message monitoring component 735 is capable of, configured to, or operable to support a means for monitoring for the at least one control message of the first control channel of the set of multiple control channels via the first control channel element of the first PRG of the set of multiple PRGs and via the second control channel element of the first PRG of the set of multiple PRGs based on the quantity of REG bundles per PRG of the set of multiple PRGs being coprime to the width of the REG bundle interleaver that interleaved the at least one control message into the first control channel element and the second control channel element.

In some examples, to support monitoring, the control message monitoring component 735 is capable of, configured to, or operable to support a means for monitoring for the at least one control message of the first control channel of the set of multiple control channels via the first control channel element of the first PRG of the set of multiple PRGs and via the second control channel element of the first PRG of the set of multiple PRGs based on each REG bundle of the quantity of the set of multiple REG bundles being shifted by the different cyclic shift in the respective PRG of the set of multiple PRGs.

In some examples, the reference signal sharing is demodulation reference signal sharing.

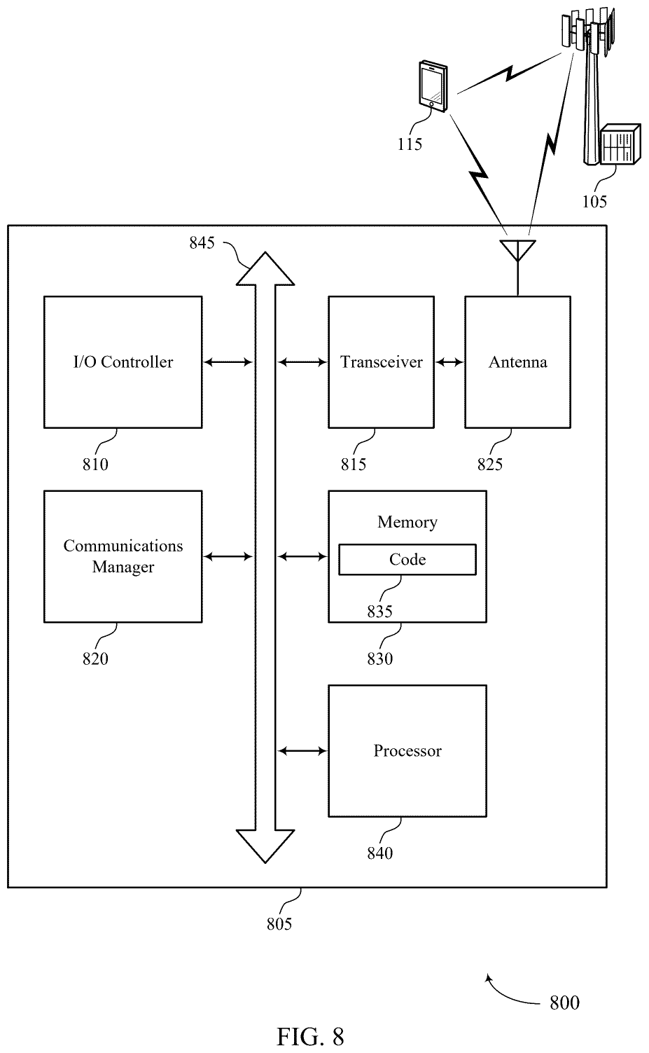

FIG. 8 shows a diagram of a system 800 including a device 805 that supports an REG bundle cyclic shift in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting an REG bundle cyclic shift). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling indicating a control channel configuration associated with reference signal sharing across a set of multiple control channels of a control resource set and with cycling of a set of multiple REG bundles in a set of multiple PRGs of the control resource set. The communications manager 820 is capable of, configured to, or operable to support a means for receiving a set of multiple reference signals via the set of multiple PRGs of the control resource set. The communications manager 820 is capable of, configured to, or operable to support a means for monitoring for at least one control message of a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

By including or configuring the communications manager 820 in accordance with examples as described herein, the device 805 may support techniques for improved communication reliability, reduced power consumption, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of an REG bundle cyclic shift as described herein, or the at least one processor 840 and the at least one memory 830 may be otherwise configured to, individually or collectively, perform or support such operations.

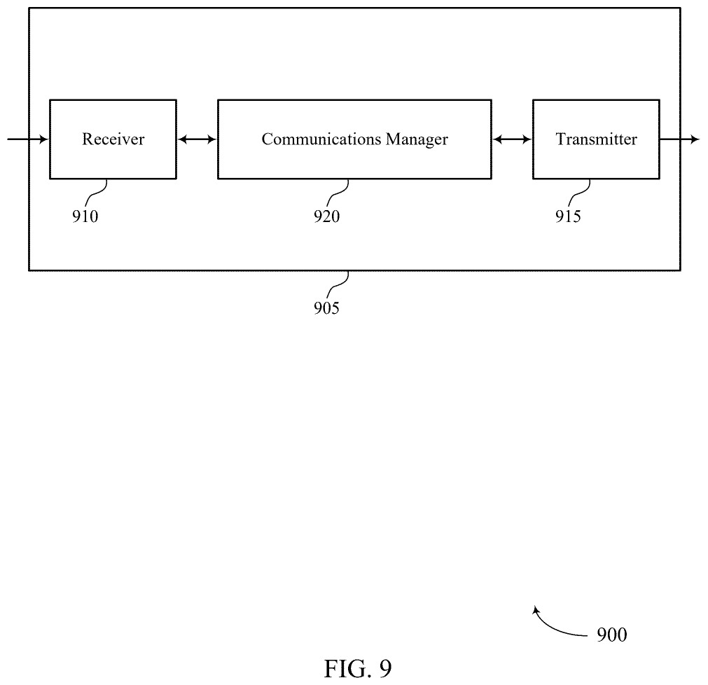

FIG. 9 shows a block diagram 900 of a device 905 that supports an REG bundle cyclic shift in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of an REG bundle cyclic shift as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting control signaling indicating a control channel configuration associated with reference signal sharing across a set of multiple control channels of a control resource set and with cycling of a set of multiple REG bundles in a set of multiple PRGs of the control resource set. The communications manager 920 is capable of, configured to, or operable to support a means for outputting a set of multiple reference signals via the set of multiple PRGs of the control resource set. The communications manager 920 is capable of, configured to, or operable to support a means for outputting at least one control message on a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

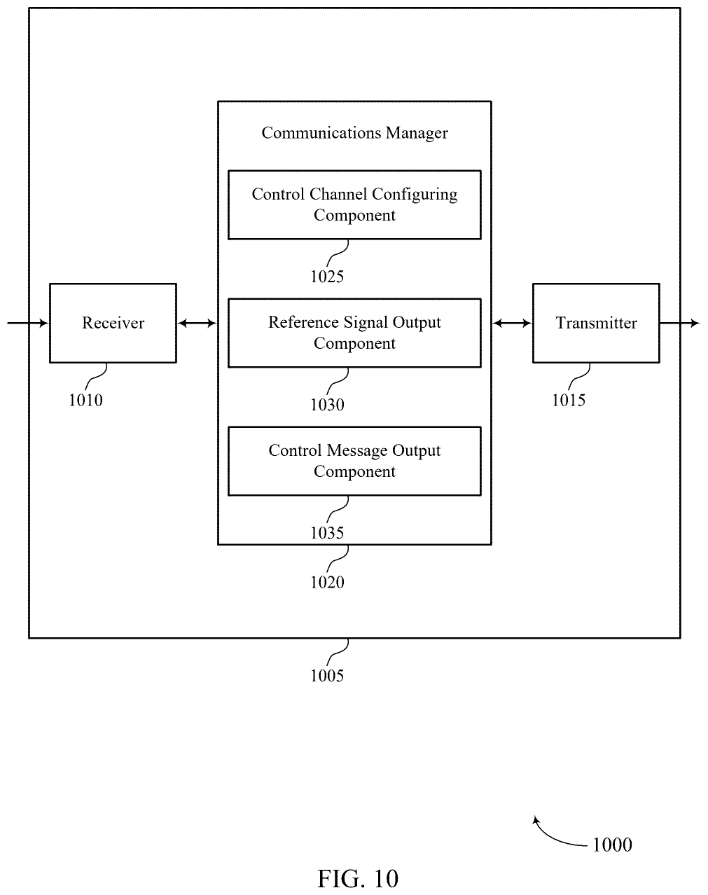

FIG. 10 shows a block diagram 1000 of a device 1005 that supports an REG bundle cyclic shift in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of REG bundle cyclic shift as described herein. For example, the communications manager 1020 may include a control channel configuring component 1025, a reference signal output component 1030, a control message output component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control channel configuring component 1025 is capable of, configured to, or operable to support a means for outputting control signaling indicating a control channel configuration associated with reference signal sharing across a set of multiple control channels of a control resource set and with cycling of a set of multiple REG bundles in a set of multiple PRGs of the control resource set. The reference signal output component 1030 is capable of, configured to, or operable to support a means for outputting a set of multiple reference signals via the set of multiple PRGs of the control resource set. The control message output component 1035 is capable of, configured to, or operable to support a means for outputting at least one control message on a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

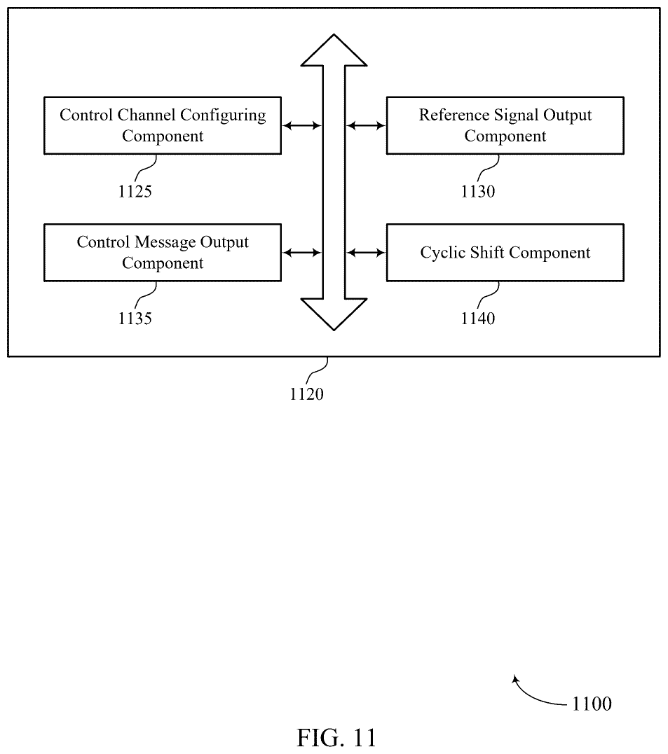

FIG. 11 shows a block diagram 1100 of a communications manager 1120 that supports an REG bundle cyclic shift in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of REG bundle cyclic shift as described herein. For example, the communications manager 1120 may include a control channel configuring component 1125, a reference signal output component 1130, a control message output component 1135, a cyclic shift component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control channel configuring component 1125 is capable of, configured to, or operable to support a means for outputting control signaling indicating a control channel configuration associated with reference signal sharing across a set of multiple control channels of a control resource set and with cycling of a set of multiple REG bundles in a set of multiple PRGs of the control resource set. The reference signal output component 1130 is capable of, configured to, or operable to support a means for outputting a set of multiple reference signals via the set of multiple PRGs of the control resource set. The control message output component 1135 is capable of, configured to, or operable to support a means for outputting at least one control message on a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

In some examples, the control message output component 1135 is capable of, configured to, or operable to support a means for outputting a second control message on a second control channel of the set of multiple control channels via a third control channel element of the first PRG of the set of multiple PRGs, where the at least one control message is output to a first UE, and the second control message is output to a second UE.

In some examples, the control channel configuring component 1125 is capable of, configured to, or operable to support a means for selecting the quantity of REG bundles per PRG to be coprime to the width of the REG bundle interleaver.

In some examples, the control channel configuring component 1125 is capable of, configured to, or operable to support a means for selecting a quantity of REGs in an REG bundle, a quantity of REG bundles in the set of multiple REG bundles, and the width of the REG bundle interleaver, where the quantity of REG bundles per PRG is coprime to the width of the REG bundle interleaver based on the selecting.

In some examples, the cyclic shift component 1140 is capable of, configured to, or operable to support a means for applying a first cyclic shift for the first PRG of the set of multiple PRGs. In some examples, the cyclic shift component 1140 is capable of, configured to, or operable to support a means for applying a second cyclic shift for the second PRG based on each REG bundle of the set of multiple REG bundles being shifted by the different cyclic shift in the respective PRG of the set of multiple PRGs.

In some examples, the control channel configuration indicates the quantity of PRG bundles per PRG of the set of multiple PRGs.

In some examples, the control channel configuration indicates the width of the REG bundle interleaver, a depth of the REG bundle interleaver, a total quantity of REGs, a quantity of REG bundles per control channel element, a bandwidth size of the control resource set, a quantity of REGs per PRG, or any combination thereof.

In some examples, the control channel configuration indicates a first cyclic shift for the first PRG of the set of multiple PRGs.

In some examples, a second cyclic shift for the second PRG of the set of multiple PRGs is based on the quantity of REG bundles per PRG.

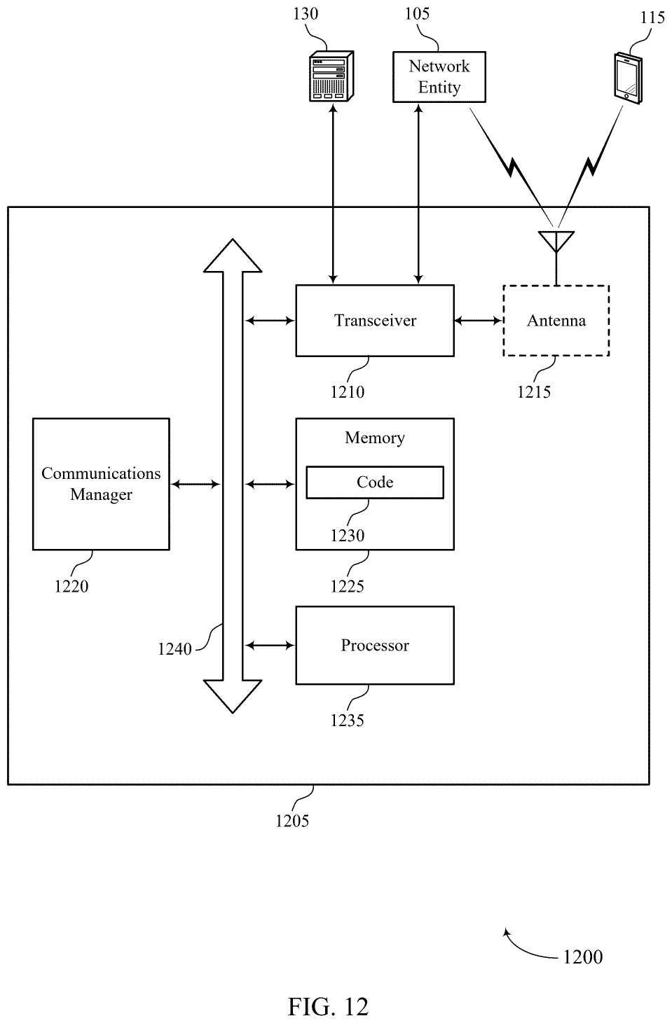

FIG. 12 shows a diagram of a system 1200 including a device 1205 that supports an REG bundle cyclic shift in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting REG bundle cyclic shift). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting control signaling indicating a control channel configuration associated with reference signal sharing across a set of multiple control channels of a control resource set and with cycling of a set of multiple REG bundles in a set of multiple PRGs of the control resource set. The communications manager 1220 is capable of, configured to, or operable to support a means for outputting a set of multiple reference signals via the set of multiple PRGs of the control resource set. The communications manager 1220 is capable of, configured to, or operable to support a means for outputting at least one control message on a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs.

By including or configuring the communications manager 1220 in accordance with examples as described herein, the device 1205 may support techniques for improved communication reliability, reduced power consumption, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of an REG bundle cyclic shift as described herein, or the at least one processor 1235 and the at least one memory 1225 may be otherwise configured to, individually or collectively, perform or support such operations.

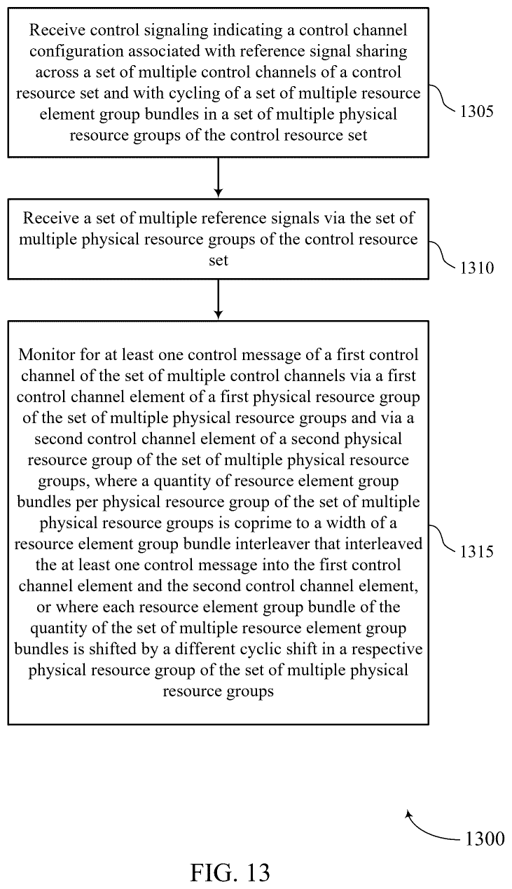

FIG. 13 shows a flowchart illustrating a method 1300 that supports an REG bundle cyclic shift in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a control channel configuration associated with reference signal sharing across a set of multiple control channels of a control resource set and with cycling of a set of multiple REG bundles in a set of multiple PRGs of the control resource set. The operations of 1305 may be performed in accordance with examples as disclosed herein. In some examples, aspects of the operations of 1305 may be performed by a control channel configuration component 725 as described with reference to FIG. 7.

At 1310, the method may include receiving a set of multiple reference signals via the set of multiple PRGs of the control resource set. The operations of 1310 may be performed in accordance with examples as disclosed herein. In some examples, aspects of the operations of 1310 may be performed by a reference signal reception component 730 as described with reference to FIG. 7.

At 1315, the method may include monitoring for at least one control message of a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs. The operations of 1315 may be performed in accordance with examples as disclosed herein. In some examples, aspects of the operations of 1315 may be performed by a control message monitoring component 735 as described with reference to FIG. 7.

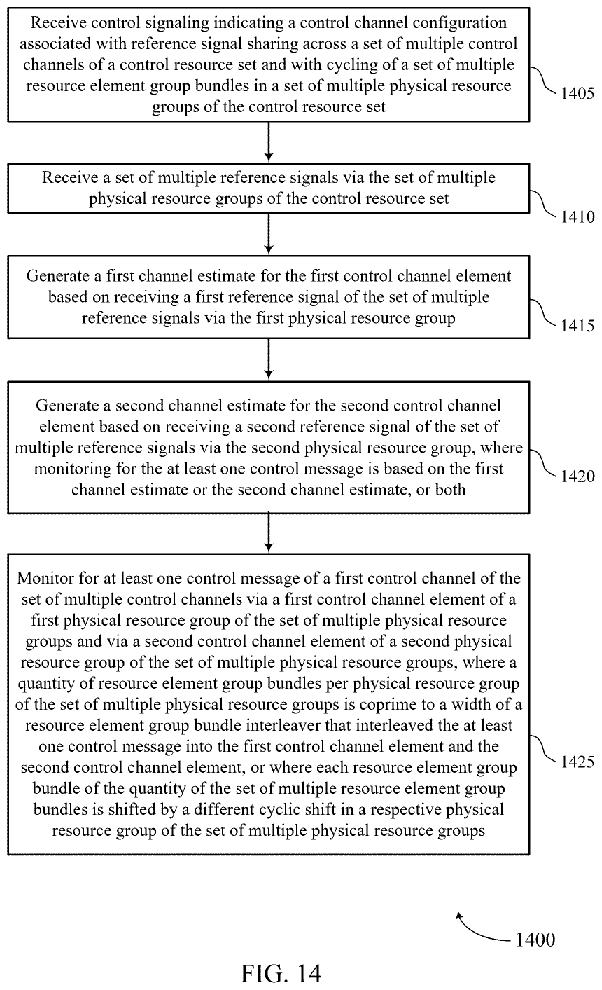

FIG. 14 shows a flowchart illustrating a method 1400 that supports an REG bundle cyclic shift in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a control channel configuration associated with reference signal sharing across a set of multiple control channels of a control resource set and with cycling of a set of multiple REG bundles in a set of multiple PRGs of the control resource set. The operations of 1405 may be performed in accordance with examples as disclosed herein. In some examples, aspects of the operations of 1405 may be performed by a control channel configuration component 725 as described with reference to FIG. 7.

At 1410, the method may include receiving a set of multiple reference signals via the set of multiple PRGs of the control resource set. The operations of 1410 may be performed in accordance with examples as disclosed herein. In some examples, aspects of the operations of 1410 may be performed by a reference signal reception component 730 as described with reference to FIG. 7.

At 1415, the method may include generating a first channel estimate for the first control channel element based on receiving a first reference signal of the set of multiple reference signals via the first PRG. The operations of 1415 may be performed in accordance with examples as disclosed herein. In some examples, aspects of the operations of 1415 may be performed by a channel estimate component 740 as described with reference to FIG. 7.

At 1420, the method may include generating a second channel estimate for the second control channel element based on receiving a second reference signal of the set of multiple reference signals via the second PRG, where monitoring for the at least one control message is based on the first channel estimate or the second channel estimate, or both. The operations of 1420 may be performed in accordance with examples as disclosed herein. In some examples, aspects of the operations of 1420 may be performed by a channel estimate component 740 as described with reference to FIG. 7.

At 1425, the method may include monitoring for at least one control message of a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs. The operations of 1425 may be performed in accordance with examples as disclosed herein. In some examples, aspects of the operations of 1425 may be performed by a control message monitoring component 735 as described with reference to FIG. 7.

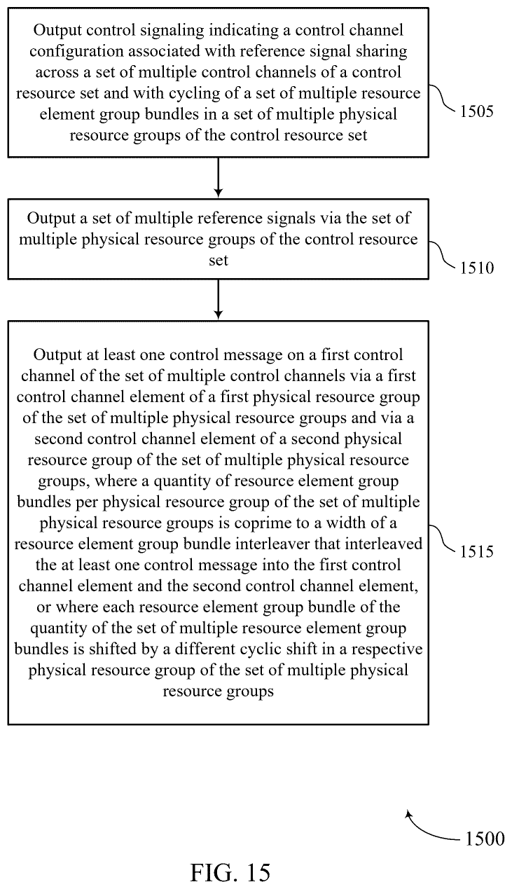

FIG. 15 shows a flowchart illustrating a method 1500 that supports an REG bundle cyclic shift in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting control signaling indicating a control channel configuration associated with reference signal sharing across a set of multiple control channels of a control resource set and with cycling of a set of multiple REG bundles in a set of multiple PRGs of the control resource set. The operations of 1505 may be performed in accordance with examples as disclosed herein. In some examples, aspects of the operations of 1505 may be performed by a control channel configuring component 1125 as described with reference to FIG. 11.

At 1510, the method may include outputting a set of multiple reference signals via the set of multiple PRGs of the control resource set. The operations of 1510 may be performed in accordance with examples as disclosed herein. In some examples, aspects of the operations of 1510 may be performed by a reference signal output component 1130 as described with reference to FIG. 11.

At 1515, the method may include outputting at least one control message on a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs. The operations of 1515 may be performed in accordance with examples as disclosed herein. In some examples, aspects of the operations of 1515 may be performed by a control message output component 1135 as described with reference to FIG. 11.

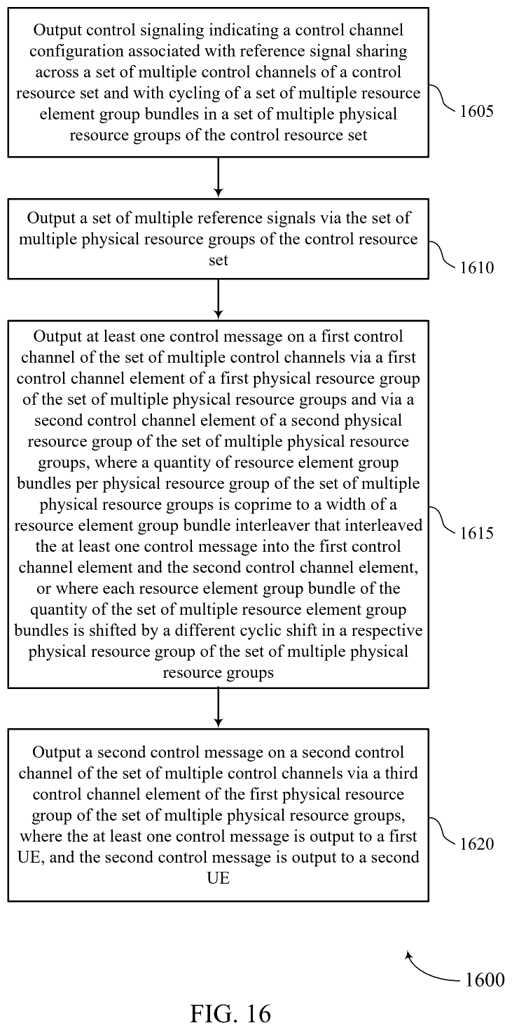

FIG. 16 shows a flowchart illustrating a method 1600 that supports an REG bundle cyclic shift in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting control signaling indicating a control channel configuration associated with reference signal sharing across a set of multiple control channels of a control resource set and with cycling of a set of multiple REG bundles in a set of multiple PRGs of the control resource set. The operations of 1605 may be performed in accordance with examples as disclosed herein. In some examples, aspects of the operations of 1605 may be performed by a control channel configuring component 1125 as described with reference to FIG. 11.

At 1610, the method may include outputting a set of multiple reference signals via the set of multiple PRGs of the control resource set. The operations of 1610 may be performed in accordance with examples as disclosed herein. In some examples, aspects of the operations of 1610 may be performed by a reference signal output component 1130 as described with reference to FIG. 11.

At 1615, the method may include outputting at least one control message on a first control channel of the set of multiple control channels via a first control channel element of a first PRG of the set of multiple PRGs and via a second control channel element of a second PRG of the set of multiple PRGs, where a quantity of REG bundles per PRG of the set of multiple PRGs is coprime to a width of an REG bundle interleaver that interleaved the at least one control message into the first control channel element and the second control channel element, or where each REG bundle of the quantity of the set of multiple REG bundles is shifted by a different cyclic shift in a respective PRG of the set of multiple PRGs. The operations of 1615 may be performed in accordance with examples as disclosed herein. In some examples, aspects of the operations of 1615 may be performed by a control message output component 1135 as described with reference to FIG. 11.

At 1620, the method may include outputting a second control message on a second control channel of the set of multiple control channels via a third control channel element of the first PRG of the set of multiple PRGs, where the at least one control message is output to a first UE, and the second control message is output to a second UE. The operations of 1620 may be performed in accordance with examples as disclosed herein. In some examples, aspects of the operations of 1620 may be performed by a control message output component 1135 as described with reference to FIG. 11.

The following provides an overview of aspects of the present disclosure:
Aspect 1: A method for wireless communications at a UE, comprising: receiving control signaling indicating a control channel configuration associated with reference signal sharing across a plurality of control channels of a control resource set and with cycling of a plurality of resource element group bundles in a plurality of physical resource groups of the control resource set; receiving a plurality of reference signals via the plurality of physical resource groups of the control resource set; and monitoring for at least one control message of a first control channel of the plurality of control channels via a first control channel element of a first physical resource group of the plurality of physical resource groups and via a second control channel element of a second physical resource group of the plurality of physical resource groups, wherein a quantity of resource element group bundles per physical resource group of the plurality of physical resource groups is coprime to a width of a resource element group bundle interleaver that interleaved the at least one control message into the first control channel element and the second control channel element, or wherein each resource element group bundle of the quantity of the plurality of resource element group bundles is shifted by a different cyclic shift in a respective physical resource group of the plurality of physical resource groups.
Aspect 2: The method of aspect 1, further comprising: generating a first channel estimate for the first control channel element based at least in part on receiving a first reference signal of the plurality of reference signals via the first physical resource group; and generating a second channel estimate for the second control channel element based at least in part on receiving a second reference signal of the plurality of reference signals via the second physical resource group, wherein monitoring for the at least one control message is based at least in part on the first channel estimate or the second channel estimate, or both.
Aspect 3: The method of any of aspects 1 through 2, wherein the control channel configuration indicates the quantity of physical resource group bundles per physical resource group of the plurality of physical resource groups.
Aspect 4: The method of any of aspects 1 through 3, wherein the control channel configuration indicates the width of the resource element group bundle interleaver, a depth of the resource element group bundle interleaver, a total quantity of resource element groups, a quantity of resource element group bundles per control channel element, a bandwidth size of the control resource set, or a quantity of resource element groups per physical resource group, or any combination thereof.
Aspect 5: The method of any of aspects 1 through 4, wherein the control channel configuration indicates a first cyclic shift for the first physical resource group of the plurality of physical resource groups.
Aspect 6: The method of aspect 5, wherein a second cyclic shift for the second physical resource group of the plurality of physical resource groups is based at least in part on the quantity of resource element group bundles per physical resource group.
Aspect 7: The method of any of aspects 1 through 6, wherein the monitoring comprises: monitoring for the at least one control message of the first control channel of the plurality of control channels via the first control channel element of the first physical resource group of the plurality of physical resource groups and via the second control channel element of the first physical resource group of the plurality of physical resource groups based at least in part on the quantity of resource element group bundles per physical resource group of the plurality of physical resource groups being coprime to the width of the resource element group bundle interleaver that interleaved the at least one control message into the first control channel element and the second control channel element.
Aspect 8: The method of any of aspects 1 through 7, wherein the monitoring comprises: monitoring for the at least one control message of the first control channel of the plurality of control channels via the first control channel element of the first physical resource group of the plurality of physical resource groups and via the second control channel element of the first physical resource group of the plurality of physical resource groups based at least in part on each resource element group bundle of the quantity of the plurality of resource element group bundles being shifted by the different cyclic shift in the respective physical resource group of the plurality of physical resource groups.
Aspect 9: The method of any of aspects 1 through 8, wherein the reference signal sharing is demodulation reference signal sharing.
Aspect 10: A method for wireless communications at a network entity, comprising: outputting control signaling indicating a control channel configuration associated with reference signal sharing across a plurality of control channels of a control resource set and with cycling of a plurality of resource element group bundles in a plurality of physical resource groups of the control resource set; outputting a plurality of reference signals via the plurality of physical resource groups of the control resource set; and outputting at least one control message on a first control channel of the plurality of control channels via a first control channel element of a first physical resource group of the plurality of physical resource groups and via a second control channel element of a second physical resource group of the plurality of physical resource groups, wherein a quantity of resource element group bundles per physical resource group of the plurality of physical resource groups is coprime to a width of a resource element group bundle interleaver that interleaved the at least one control message into the first control channel element and the second control channel element, or wherein each resource element group bundle of the quantity of the plurality of resource element group bundles is shifted by a different cyclic shift in a respective physical resource group of the plurality of physical resource groups.
Aspect 11: The method of aspect 10, further comprising: outputting a second control message on a second control channel of the plurality of control channels via a third control channel element of the first physical resource group of the plurality of physical resource groups, wherein the at least one control message is output to a first UE, and the second control message is output to a second UE.
Aspect 12: The method of any of aspects 10 through 11, further comprising: selecting the quantity of resource element group bundles per physical resource group to be coprime to the width of the resource element group bundle interleaver.
Aspect 13: The method of any of aspects 10 through 12, further comprising: selecting a quantity of resource element groups in a resource element group bundle, a quantity of resource element group bundles in the plurality of resource element group bundles, and the width of the resource element group bundle interleaver, wherein the quantity of resource element group bundles per physical resource group is coprime to the width of the resource element group bundle interleaver based at least in part on the selecting.
Aspect 14: The method of any of aspects 10 through 13, further comprising: applying a first cyclic shift for the first physical resource group of the plurality of physical resource groups; applying a second cyclic shift for the second physical resource group based at least in part on each resource element group bundle of the plurality of resource element group bundles being shifted by the different cyclic shift in the respective physical resource group of the plurality of physical resource groups.
Aspect 15: The method of any of aspects 10 through 14, wherein the control channel configuration indicates the quantity of physical resource group bundles per physical resource group of the plurality of physical resource groups.
Aspect 16: The method of any of aspects 10 through 15, wherein the control channel configuration indicates the width of the resource element group bundle interleaver, a depth of the resource element group bundle interleaver, a total quantity of resource element groups, a quantity of resource element group bundles per control channel element, a bandwidth size of the control resource set, a quantity of resource element groups per physical resource group, or any combination thereof.
Aspect 17: The method of any of aspects 10 through 16, wherein the control channel configuration indicates a first cyclic shift for the first physical resource group of the plurality of physical resource groups.
Aspect 18: The method of aspect 17, wherein a second cyclic shift for the second physical resource group of the plurality of physical resource groups is based at least in part on the quantity of resource element group bundles per physical resource group.
Aspect 19: A UE for wireless communications, comprising one or more memories storing processor-executable code, and one or more processors coupled with the one or more memories and individually or collectively operable to execute the code to cause the UE to perform a method of any of aspects 1 through 9.
Aspect 20: A UE for wireless communications, comprising at least one means for performing a method of any of aspects 1 through 9.
Aspect 21: A non-transitory computer-readable medium storing code for wireless communications, the code comprising instructions executable by one or more processors to perform a method of any of aspects 1 through 9.
Aspect 22: A network entity for wireless communications, comprising one or more memories storing processor-executable code, and one or more processors coupled with the one or more memories and individually or collectively operable to execute the code to cause the network entity to perform a method of any of aspects 10 through 18.
Aspect 23: A network entity for wireless communications, comprising at least one means for performing a method of any of aspects 10 through 18.
Aspect 24: A non-transitory computer-readable medium storing code for wireless communications, the code comprising instructions executable by one or more processors to perform a method of any of aspects 10 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a control channel configuration associated with reference signal sharing across a plurality of control channels of a control resource set and with cycling of a plurality of resource element group bundles in a plurality of physical resource groups of the control resource set;
receive a plurality of reference signals via the plurality of physical resource groups of the control resource set; and
monitor for at least one control message of a first control channel of the plurality of control channels via a first control channel element of a first physical resource group of the plurality of physical resource groups and via a second control channel element of a second physical resource group of the plurality of physical resource groups, wherein a quantity of resource element group bundles per physical resource group of the plurality of physical resource groups is coprime to a width of a resource element group bundle interleaver that interleaved the at least one control message into the first control channel element and the second control channel element, or wherein each resource element group bundle of the quantity of the plurality of resource element group bundles is shifted by a different cyclic shift in a respective physical resource group of the plurality of physical resource groups.

2. The UE of claim 1, wherein the one or more processors are individually or collectively further operable to execute the code to cause the UE to:
generate a first channel estimate for the first control channel element based at least in part on receiving a first reference signal of the plurality of reference signals via the first physical resource group; and
generate a second channel estimate for the second control channel element based at least in part on receiving a second reference signal of the plurality of reference signals via the second physical resource group, wherein monitoring for the at least one control message is based at least in part on the first channel estimate or the second channel estimate, or both.

3. The UE of claim 1, wherein the control channel configuration indicates the quantity of physical resource group bundles per physical resource group of the plurality of physical resource groups.

4. The UE of claim 1, wherein the control channel configuration indicates the width of the resource element group bundle interleaver, a depth of the resource element group bundle interleaver, a total quantity of resource element groups, a quantity of resource element group bundles per control channel element, a bandwidth size of the control resource set, or a quantity of resource element groups per physical resource group, or any combination thereof.

5. The UE of claim 1, wherein the control channel configuration indicates a first cyclic shift for the first physical resource group of the plurality of physical resource groups.

6. The UE of claim 5, wherein a second cyclic shift for the second physical resource group of the plurality of physical resource groups is based at least in part on the quantity of resource element group bundles per physical resource group.

7. The UE of claim 1, wherein, to monitor, the one or more processors are individually or collectively operable to execute the code to cause the UE to:
monitor for the at least one control message of the first control channel of the plurality of control channels via the first control channel element of the first physical resource group of the plurality of physical resource groups and via the second control channel element of the first physical resource group of the plurality of physical resource groups based at least in part on the quantity of resource element group bundles per physical resource group of the plurality of physical resource groups being coprime to the width of the resource element group bundle interleaver that interleaved the at least one control message into the first control channel element and the second control channel element.

8. The UE of claim 1, wherein, to monitor, the one or more processors are individually or collectively operable to execute the code to cause the UE to:
monitor for the at least one control message of the first control channel of the plurality of control channels via the first control channel element of the first physical resource group of the plurality of physical resource groups and via the second control channel element of the first physical resource group of the plurality of physical resource groups based at least in part on each resource element group bundle of the quantity of the plurality of resource element group bundles being shifted by the different cyclic shift in the respective physical resource group of the plurality of physical resource groups.

9. The UE of claim 1, wherein:
the reference signal sharing is demodulation reference signal sharing.

10. A network entity, comprising:
one or more memories storing processor-executable code; and
one or more processors coupled with the one or more memories and individually or collectively operable to execute the code to cause the network entity to:
output control signaling indicating a control channel configuration associated with reference signal sharing across a plurality of control channels of a control resource set and with cycling of a plurality of resource element group bundles in a plurality of physical resource groups of the control resource set;
output a plurality of reference signals via the plurality of physical resource groups of the control resource set; and
output at least one control message on a first control channel of the plurality of control channels via a first control channel element of a first physical resource group of the plurality of physical resource groups and via a second control channel element of a second physical resource group of the plurality of physical resource groups, wherein a quantity of resource element group bundles per physical resource group of the plurality of physical resource groups is coprime to a width of a resource element group bundle interleaver that interleaved the at least one control message into the first control channel element and the second control channel element, or wherein each resource element group bundle of the quantity of the plurality of resource element group bundles is shifted by a different cyclic shift in a respective physical resource group of the plurality of physical resource groups.

11. The network entity of claim 10, wherein the one or more processors are individually or collectively further operable to execute the code to cause the network entity to:
output a second control message on a second control channel of the plurality of control channels via a third control channel element of the first physical resource group of the plurality of physical resource groups, wherein the at least one control message is output to a first user equipment (UE), and the second control message is output to a second UE.

12. The network entity of claim 10, wherein the one or more processors are individually or collectively further operable to execute the code to cause the network entity to:
select the quantity of resource element group bundles per physical resource group to be coprime to the width of the resource element group bundle interleaver.

13. The network entity of claim 10, wherein the one or more processors are individually or collectively further operable to execute the code to cause the network entity to:
select a quantity of resource element groups in a resource element group bundle, a quantity of resource element group bundles in the plurality of resource element group bundles, and the width of the resource element group bundle interleaver, wherein the quantity of resource element group bundles per physical resource group is coprime to the width of the resource element group bundle interleaver based at least in part on the selecting.

14. The network entity of claim 10, wherein the one or more processors are individually or collectively further operable to execute the code to cause the network entity to:
apply a first cyclic shift for the first physical resource group of the plurality of physical resource groups;
apply a second cyclic shift for the second physical resource group based at least in part on each resource element group bundle of the plurality of resource element group bundles being shifted by the different cyclic shift in the respective physical resource group of the plurality of physical resource groups.

15. The network entity of claim 10, wherein the control channel configuration indicates the quantity of physical resource group bundles per physical resource group of the plurality of physical resource groups.

16. The network entity of claim 10, wherein the control channel configuration indicates the width of the resource element group bundle interleaver, a depth of the resource element group bundle interleaver, a total quantity of resource element groups, a quantity of resource element group bundles per control channel element, a bandwidth size of the control resource set, a quantity of resource element groups per physical resource group, or any combination thereof.

17. The network entity of claim 10, wherein the control channel configuration indicates a first cyclic shift for the first physical resource group of the plurality of physical resource groups.

18. The network entity of claim 17, wherein a second cyclic shift for the second physical resource group of the plurality of physical resource groups is based at least in part on the quantity of resource element group bundles per physical resource group.

19. A method for wireless communications at a user equipment (UE), comprising:
receiving control signaling indicating a control channel configuration associated with reference signal sharing across a plurality of control channels of a control resource set and with cycling of a plurality of resource element group bundles in a plurality of physical resource groups of the control resource set;
receiving a plurality of reference signals via the plurality of physical resource groups of the control resource set; and
monitoring for at least one control message of a first control channel of the plurality of control channels via a first control channel element of a first physical resource group of the plurality of physical resource groups and via a second control channel element of a second physical resource group of the plurality of physical resource groups, wherein a quantity of resource element group bundles per physical resource group of the plurality of physical resource groups is coprime to a width of a resource element group bundle interleaver that interleaved the at least one control message into the first control channel element and the second control channel element, or wherein each resource element group bundle of the quantity of the plurality of resource element group bundles is shifted by a different cyclic shift in a respective physical resource group of the plurality of physical resource groups.

20. The method of claim 19, further comprising:
generating a first channel estimate for the first control channel element based at least in part on receiving a first reference signal of the plurality of reference signals via the first physical resource group; and
generating a second channel estimate for the second control channel element based at least in part on receiving a second reference signal of the plurality of reference signals via the second physical resource group, wherein monitoring for the at least one control message is based at least in part on the first channel estimate or the second channel estimate, or both.

21. The method of claim 19, wherein the control channel configuration indicates the quantity of physical resource group bundles per physical resource group of the plurality of physical resource groups.

22. The method of claim 19, wherein the control channel configuration indicates the width of the resource element group bundle interleaver, a depth of the resource element group bundle interleaver, a total quantity of resource element groups, a quantity of resource element group bundles per control channel element, a bandwidth size of the control resource set, or a quantity of resource element groups per physical resource group, or any combination thereof.

23. The method of claim 19, wherein the control channel configuration indicates a first cyclic shift for the first physical resource group of the plurality of physical resource groups.

24. The method of claim 23, wherein a second cyclic shift for the second physical resource group of the plurality of physical resource groups is based at least in part on the quantity of resource element group bundles per physical resource group.

25. The method of claim 19, wherein the monitoring comprises:
monitoring for the at least one control message of the first control channel of the plurality of control channels via the first control channel element of the first physical resource group of the plurality of physical resource groups and via the second control channel element of the first physical resource group of the plurality of physical resource groups based at least in part on the quantity of resource element group bundles per physical resource group of the plurality of physical resource groups being coprime to the width of the resource element group bundle interleaver that interleaved the at least one control message into the first control channel element and the second control channel element.

26. The method of claim 19, wherein the monitoring comprises:
monitoring for the at least one control message of the first control channel of the plurality of control channels via the first control channel element of the first physical resource group of the plurality of physical resource groups and via the second control channel element of the first physical resource group of the plurality of physical resource groups based at least in part on each resource element group bundle of the quantity of the plurality of resource element group bundles being shifted by the different cyclic shift in the respective physical resource group of the plurality of physical resource groups.

27. The method of claim 19, wherein the reference signal sharing is demodulation reference signal sharing.

28. A method for wireless communications at a network entity, comprising:
outputting control signaling indicating a control channel configuration associated with reference signal sharing across a plurality of control channels of a control resource set and with cycling of a plurality of resource element group bundles in a plurality of physical resource groups of the control resource set;
outputting a plurality of reference signals via the plurality of physical resource groups of the control resource set; and
outputting at least one control message on a first control channel of the plurality of control channels via a first control channel element of a first physical resource group of the plurality of physical resource groups and via a second control channel element of a second physical resource group of the plurality of physical resource groups, wherein a quantity of resource element group bundles per physical resource group of the plurality of physical resource groups is coprime to a width of a resource element group bundle interleaver that interleaved the at least one control message into the first control channel element and the second control channel element, or wherein each resource element group bundle of the quantity of the plurality of resource element group bundles is shifted by a different cyclic shift in a respective physical resource group of the plurality of physical resource groups.

29. The method of claim 28, further comprising:
outputting a second control message on a second control channel of the plurality of control channels via a third control channel element of the first physical resource group of the plurality of physical resource groups, wherein the at least one control message is output to a first user equipment (UE), and the second control message is output to a second UE.

30. The method of claim 28, further comprising:
selecting the quantity of resource element group bundles per physical resource group to be coprime to the width of the resource element group bundle interleaver.
